(19) United States
(12) Patent Application Publication
(10) Pub. No.: US 2014/0009260 A1
(43) Pub. Date: Jan. 9, 2014

(54) System and Method for Querying Vehicle Status at a Checkpoint using Identity Information

(71) Applicant: Jeremy Keith MATTERN, Houston, TX (US)

(72) Inventor: Jeremy Keith MATTERN, Houston, TX (US)

(21) Appl. No.: 13/544,039

(22) Filed: Jul. 9, 2012

(51) Int. Cl. G06F 7/04

(52) U.S. Cl. 340/5.8

(57) ABSTRACT

A system and method for querying vehicle status at a checkpoint using identity information is disclosed herein. In one embodiment, a method of querying vehicle status can comprise storing identity information in a data store, receiving from a checkpoint computer data from a visitor, querying the profiles using the data to locate the first profile, querying a motor vehicle database using the vehicle information, obtaining a vehicle status from the motor vehicle database, and sending the vehicle status to the chekpoint computer. First profile can be one of a plurality of profiles in the data store. Further, the data used for querying the profiles can comprise at least a portion of the identity information.

### BACKGROUND

This disclosure relates to a system and method for querying vehicle status at a checkpoint using identity information.

Security checkpoints are placed around a secured area to protect the people within the secured area. These security measures are often applied in a military installation. For years, various methods have been implemented to provide easier and faster checkpoints transactions. Most often, manual checks, body searches, or vehicle inspections are made to ensure that any individual entering a secured area does not pose a threat and would not cause violence within the premise. However, a manual check for every individual entering a facility can be time-consuming, inefficient, and inconvenient, as military installations can receive hundreds to thousands of visitors and vehicles daily. Moreover, identity information or an ID may not be a sufficient way of checking the credibility of an individual. Furthermore, vehicle records can be separate entities that are not tied into a checkpoint system. Thus, when an individual's vehicle has records of importance, such as theft, expired registration, expired insurance or no valid inspection sticker, the information may not be easily recognized and not readily available for security personnel guarding at a checkpoint.

As such, it would be useful to have an improved system and method for querying vehicle status at a checkpoint using identity information.

### SUMMARY

A system and method for querying vehicle status at a checkpoint using identity information is disclosed herein. In one embodiment, a method of querying vehicle status can comprise storing identity information in a data store, receiving from a checkpoint computer data from a visitor, querying the profiles using the data to locate the first profile, querying a motor vehicle database using the vehicle information, obtaining a vehicle status from the motor vehicle database, and sending the vehicle status to the chekpoint computer. First profile can be one of a plurality of profiles in the data store. Further, the data used for querying the profiles can comprise at least a portion of the identity information.

In another embodiment, a system for registering in a military base can comprise a computer readable storage medium having a computer readable program code embodied therein. The computer readable program code can be adapted to be executed to implement the abovementioned methods.

### BRIEF DESCRIPTION OF THE DRAWINGS

FIG. 1A illustrates an aerial view of a facility.

FIG. 1B illustrates a vehicle status checkpoint system.

FIG. 2 illustrates an embodiment of checkpoint computer as a mobile device.

FIG. 3A illustrates a front view of an identification card.

FIG. 3B illustrates a back view of an identification card.

FIG. 4A illustrates a schematic diagram of a military server.

FIG. 4B illustrate a schematic block diagram of checkpoint computer.

FIG. 5 illustrates a motor vehicle records database.

FIG. 6 illustrates a military record profile.

FIG. 7 illustrates an exemplary method for providing a pass control through vehicle status information.

### DETAILED DESCRIPTION

Described herein is a system and method for querying vehicle status at a checkpoint using identity information. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

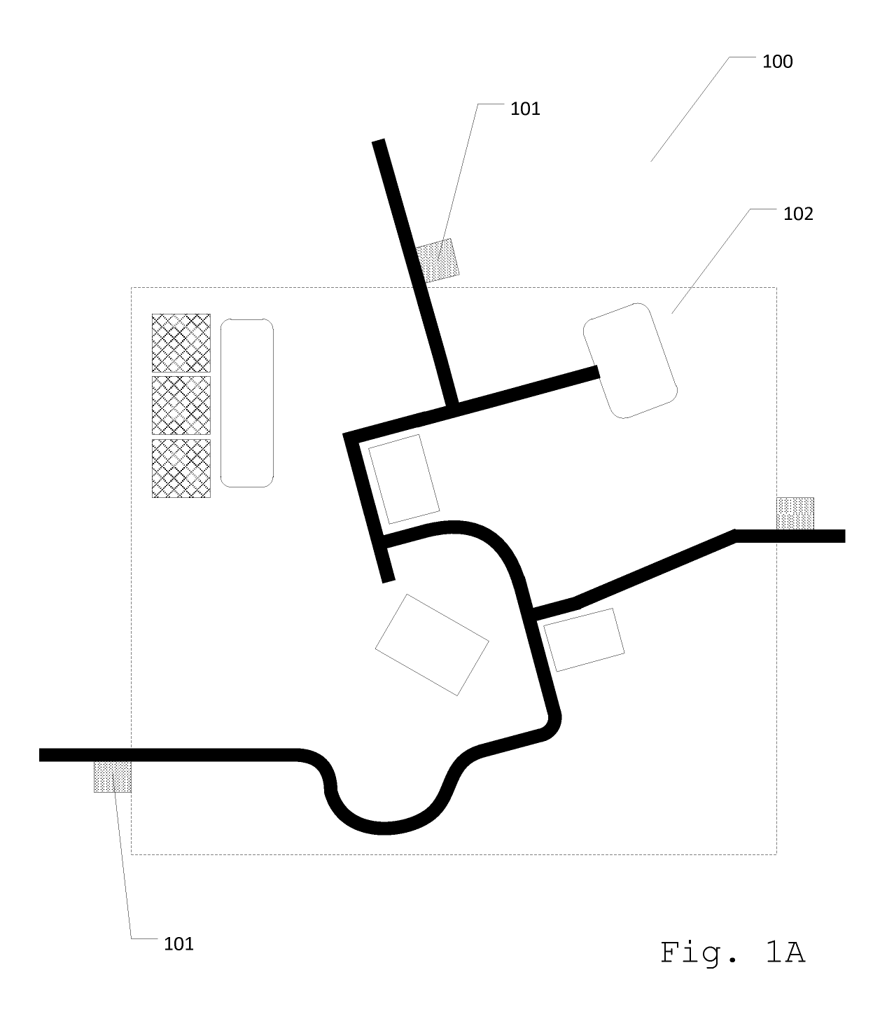

FIG. 1A illustrates an aerial view of a facility 100 comprising one or more checkpoints 101 strategically placed around secured area 102. Facility 100 can refer to any public or private installations designed to restrict unauthorized individuals from accessing, such as a military base, and/or a military installation. Secured area 102 can be the area within the border of facility 100. Secured area 102 can be the area protected and restricted by checkpoints 101. Checkpoints 101 can be a structure or an area within facility 100 that functions as an entry point into secured area 102. Vehicles and/or visitors can be subjected to inspections and background check before passing through checkpoints 101. For purposes of this disclosure, the term “visitor” can comprise any person at checkpoint 101 attempting to obtain a pass, permission, or qualification to enter secured area 102.

FIG. 1B illustrates a military server 103, a checkpoint computer 104, and a motor vehicle records database 105 connected via network 106. Military server 103 can be one or more devices capable of storing data and perform computational task across network 106. Military server 103 can be situated within facility 100. Checkpoint computer 104 can be any equipment capable of carrying out arithmetic, and logic operations. Checkpoint computer 104 can store and send out data information through network 106. Checkpoint computer 104 can include but is not limited to, a desktop, laptop and/or mobile device. Checkpoint computer 104 can be placed at each checkpoint 101, which can be accessible to authorized security personnel stationed at the entry points. Motor vehicle records database 105 can be one or more devices capable of storing data information accessible through network 106. Motor vehicle records database 105 can contain a plurality of vehicle information, which can include but is not limited to owner of the vehicle, license plate, registration number, and vehicle status and can be under the control of a state, local or federal government. Network 106 can be a wide area network (WAN), local area network (LAN), piconets, or combination of them. Network 106 can be hard-wired, wireless, or a combination of both. As examples, a LAN can be a network within a single organization while a WAN can be the Internet.

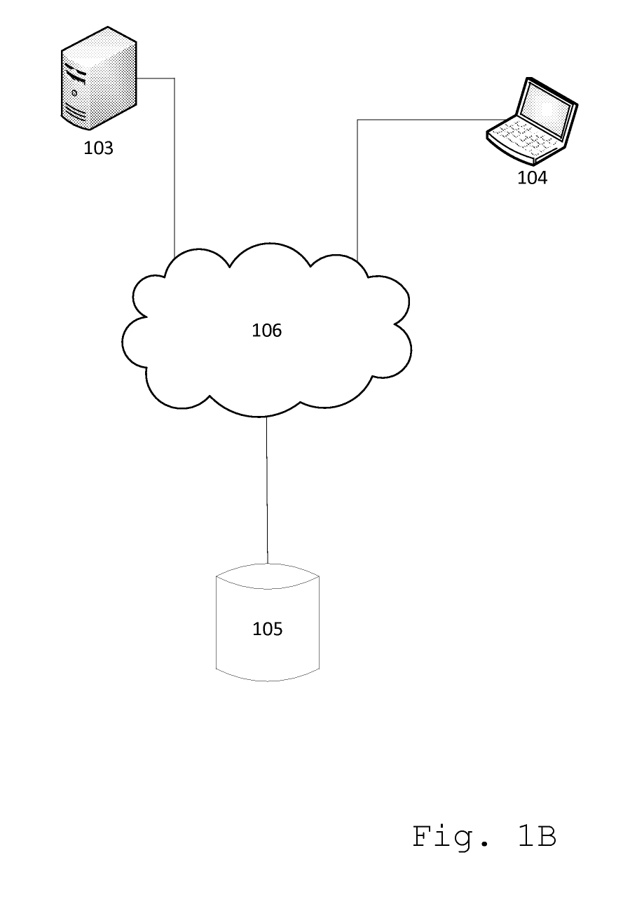

FIG. 2 illustrates an embodiment of checkpoint computer 104 as a mobile device. Mobile device can include, but is not limited to, a screen 201, a keypad 202, a card reader 203, and/or a fingerprint scanner 204. Other input devices can include track balls, joy sticks, or scroll wheels. Screen 201 can be a mere display output, or can also be a touch screen, allowing for capturing of identity information 208. Identity information 208 can include a visitor's name, military rank, serial number, grade, military organization, military installation, address, and/or date of birth. Keypad 202 can comprise of a plurality of physical buttons on mobile device, however in an embodiment were screen 201 is a touch screen, keypad 202 can be represented virtually on screen 201. Card reader 203 can read information from an identification card. An identification card can encode information in various ways. Information can be printed on the information card. Also, information can be placed on the card in a machine-readable form. Such forms can include magnetic strip, barcode or even radio frequency identification (RFID) chip. An identification card can include, but is not limited to, a civilian or military identification card, a passport, a school identification badge or a credit card. In one embodiment, card reader 203 can read a magnetic strip on an identification card. In another embodiment, card reader 203 can read information encoded in a barcode on an identification card. In another embodiment card reader 203 comprises a (RFID) chip receiver to read an RFID chip in an identification card. In one embodiment, mobile device can read information encoded in a digital fingerprint scanned from a fingerprint scanner 204. In another embodiment, card reader 203 can read an integrated circuit card such as a Smart Card.

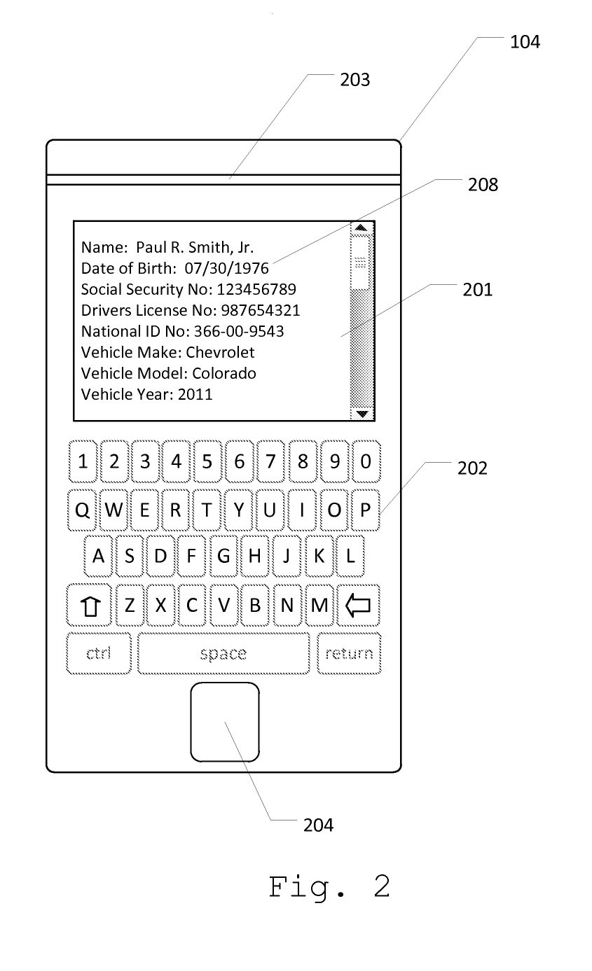

FIG. 3A illustrates a front view of an identification card 300 comprising identification card information. Identification card information can be identity information 208, and can comprise an identification number, name, address, birthday, rank, serial number, driver license number, social security number, and/or any other information encoded on identification card 300 whether written, magnetically encoded, or encoded by some other method in the art. ID can be military issued or civilian issued.

FIG. 3B illustrates a back view of identification card 300 comprising a machine-readable zone 302. Any type of device such as a card reader can read machine-readable zone 302, which is capable of decoding and transcribing identification card information from machine-readable zone 302. Machine-readable zone 302 can be in any form such as a magnetic strip, barcode or RFID chip.

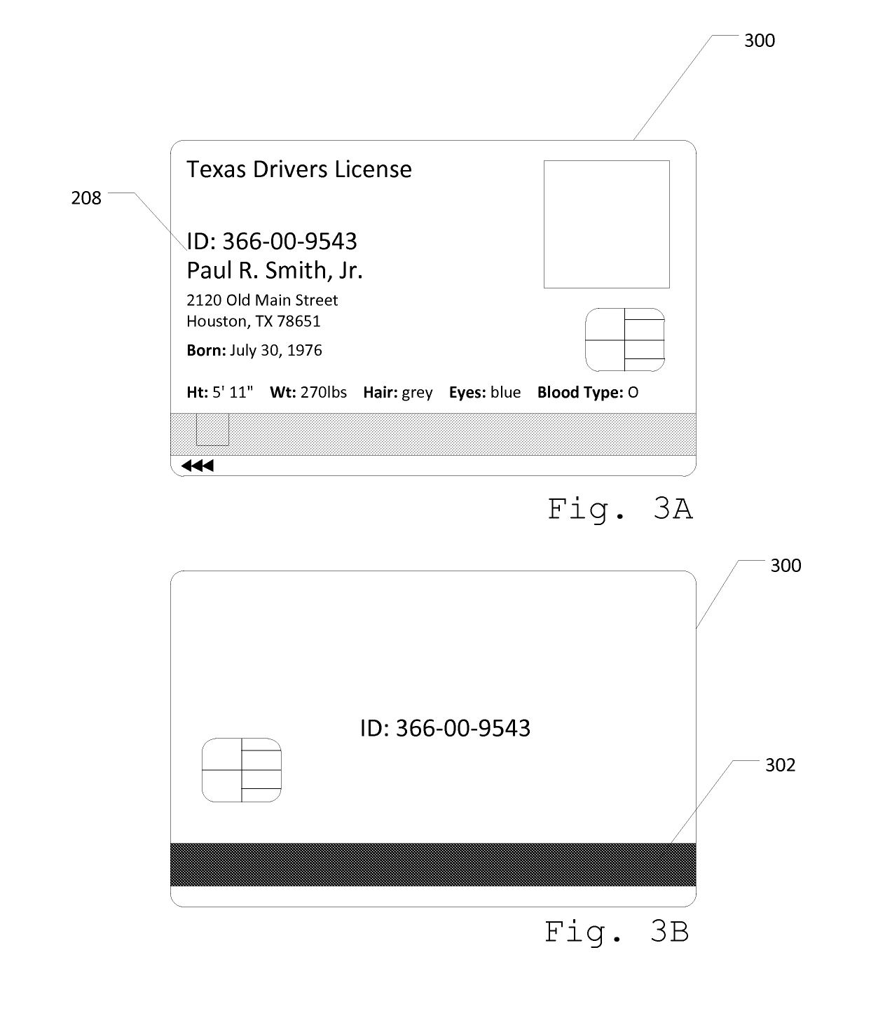

FIG. 4A illustrates a schematic diagram of military server 103 according to an embodiment of the present disclosure. Military server 103 can comprise a military processor 401, and a military memory 402 and a first local interface 403. First local interface 403 can be a program that controls a display for the user, which can allow user to view and/or interact with military server 103. Military processor 401 can be a processing unit that performs set of instructions stored within military memory 402. Military memory 402 comprises a military application 404, and military data storage 405. Military application 404 can be a program providing business logic for military server 103. Military data storage 405 can be collections of data accessible through military application 404. Further, military application 404 can perform functions such as adding, transferring and retrieving information on military data storage 405 using first local interface 403.

Military server 103 includes at least one processor circuit, for example, having military processor 401 and military memory 402, both of which are coupled to first local interface 403. To this end, the military server 103 can comprise, for example, at least one server, computer or like device. First local interface 403 can comprise, for example, a data bus with an accompanying address/control bus or other bus structure as can be appreciated.

Stored in military memory 402 described herein above are both data and several components that are executable by military processor 401. In particular, stored in the military memory 402 and executable by military processor 401 are military application 404, and potentially other applications. Also stored in military memory 402 can be a military data storage 405 and other data. In addition, an operating system can be stored in military memory 402 and executable by military processor 401.

FIG. 4B illustrate a schematic block diagram of checkpoint computer 104 according to an embodiment of the present disclosure. Checkpoint computer 104 can comprise a checkpoint processor 406, a checkpoint memory 407, and a second local interface 410. Second local interface 410 can be a program that controls a display for the user, which can allow user to view and/or interact with checkpoint computer 104. Checkpoint processor 406 can be a processing unit that performs set of instructions stored within checkpoint memory 407. Checkpoint memory 407 can include a checkpoint application 408, and a checkpoint data storage 409. Checkpoint application 408 can be a program providing business logic for checkpoint computer 104. Further, checkpoint application 408 can perform functions such as adding, updating, deleting, transferring, and retrieving information from checkpoint data storage 409.

Checkpoint computer 104 includes at least one processor circuit, for example, having checkpoint processor 406 and checkpoint memory 407, both of which are coupled to second local interface 410. To this end, the checkpoint computer 104 can comprise, for example, at least one server, computer or like device. Second local interface 410 can comprise, for example, a data bus with an accompanying address/control bus or other bus structure as can be appreciated.

Stored in checkpoint memory 407 described herein above are both data and several components that are executable by checkpoint processor 406. In particular, stored in the checkpoint memory 407 and executable by checkpoint processor 406 are checkpoint application 408, and potentially other applications. Also stored in checkpoint memory 407 can be checkpoint data storage 409 and other data. In addition, an operating system can be stored in checkpoint memory 407 and executable by checkpoint processor 406.

It is understood that there can be other applications that are stored in military memory 402 and checkpoint memory 407 and are executable by military processor 401 and checkpoint processor 406 as can be appreciated. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in military memory 402 and checkpoint memory 407 and can be executable by military processor 401 and checkpoint processor 406. In this respect, the term “executable” means a program file that is in a form that can ultimately be run by military processor 401 and checkpoint processor 406. Examples of executable programs can be, for example, a compiled program that can be translated into machine code in a format that can be loaded into a random access portion of military memory 402 and checkpoint memory 407 and run by military processor 401 and checkpoint processor 406, source code that can be expressed in proper format such as object code that is capable of being loaded into a random access portion of military memory 402 and checkpoint memory 407 and executed by military processor 401 and checkpoint processor 406, or source code that can be interpreted by another executable program to generate instructions in a random access portion of military memory 402 and checkpoint memory 407 to be executed by military processor 401 and checkpoint processor 406, etc. An executable program can be stored in any portion or component of military memory 402 and checkpoint memory 407 including, for example, random access memory (RAM), read-only memory (ROM), hard drive, solid-state drive, USB flash drive, memory card, optical disc such as compact disc (CD) or digital versatile disc (DVD), floppy disk, magnetic tape, network attached/addressable storage or other memory components.

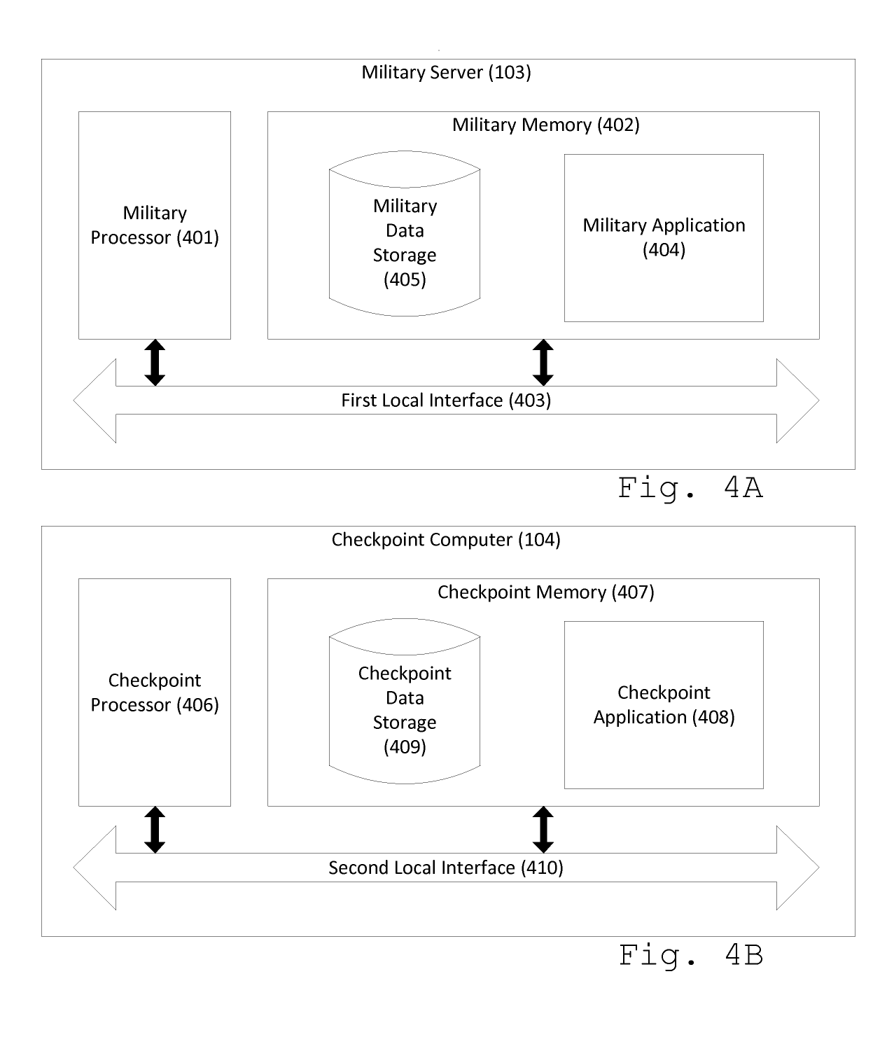

FIG. 5 illustrates a motor vehicle records database 105 comprising vehicle records. Such records can comprise a vehicle owner 501, a license number 502, a registration number 503 and/or a vehicle status 504. Vehicle owner 501 can be the name of the person possessing the vehicle. License number 502 can be a government issued alphanumeric code usually encoded in a metal or plastic plate. Registration number 503 can be a vehicle identification issued by the vehicle manufacturer, such as a vehicle identification number. Vehicle status 504 can identify the condition of a vehicle, which can tell whether a vehicle is stolen, unregistered, has expired registration, or fails to comply with state inspection laws.

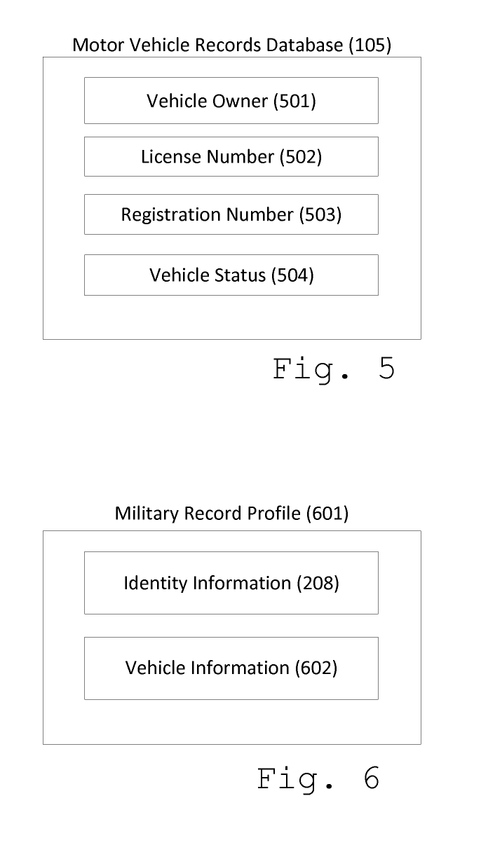

FIG. 6 illustrates a military record profile 601 stored on military data storage 405. Military record profile 601 can comprise identity information 208 and vehicle information 602. Identity information 208 and vehicle information 602 can comprise information supplied by a visitor during a registration process. Identity information 208 and vehicle information 602 can also comprise vehicle status information found on public records database and motor vehicle records database 105, by military application 404. In one embodiment, vehicle status 504 can be returned as “Cleared” to indicate clean and valid record of a car otherwise, a “Denied” status can be returned. In another embodiment, a brief vehicle history record can be returned as vehicle status 504. As such, vehicle status 504 can return a status such as, “Stolen Vehicle”, “Expired Registration”, “No State Inspection Completed or “No Records”.

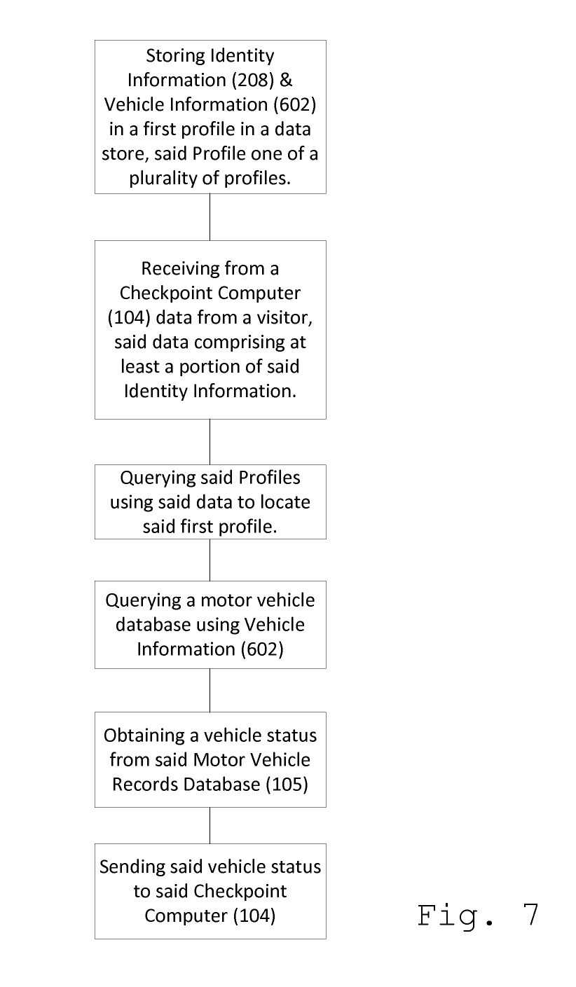

FIG. 7 illustrates an exemplary method for providing a pass control through vehicle status information. At checkpoints 101, the guards on duty can get an identification card 300 or identity information from an individual. The information can be inputted into computer 104. In one embodiment wherein checkpoint computer 104 comprises card reader 203, the guard can swipe identification card 300. In another embodiment, an individual's fingerprint can be scanned using fingerprint scanner 204. Further, in another embodiment data information can be keyed-in using keypads 202 or through screen 201 if mobile device is a touch screen.

Information entered can be sent from checkpoint computer 104, over network 106 to military server 103. Military application 404 can query motor vehicle records database 105 to collect vehicle information 602. Subsequently, identity information 208 sent by checkpoint computer 104 can be used to query vehicle information 602. Military application 404 can match associated data between identity information 208 and vehicle information 602 to determine if individual's vehicle has a “Clear” record that would allow individual to enter secured area 102. If vehicle discrepancies and other adverse vehicle information is found, military application 404 can send a “Denied” message to checkpoint computer 104. Further, a regular, periodic, and/or random query of vehicle information 602 can be made to ensure vehicle records are updated. As such, military application 404 can perform a query on motor vehicle records database 105 to retrieve updated vehicle information 602 periodically. In one embodiment, vehicle status can be updated periodically so that queries can be performed by computer 104 to military server 103 without having to wait for a response from motor vehicle records database 105.

Military memory 402 and checkpoint memory 407 is defined herein as including both volatile and nonvolatile memory and data storage components. Volatile components are those that do not retain data values upon loss of power. Nonvolatile components are those that retain data upon a loss of power. Thus, military memory 402 and checkpoint memory 407 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, network attached/addressable storage, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, military processor 401 and checkpoint processor 406 can represent multiple military processor 401 and checkpoint processor 406, and military memory 402 and checkpoint memory 407 can represent multiple military memory 402 and checkpoint memory 407 that operate in parallel processing circuits, respectively. In such a case, first local interface 403 and second local interface 410 can be an appropriate network, including network 106 that facilitates communication between any two of the multiple military processor 401 and checkpoint processor 406, between any military processor 401 and checkpoint processor 406 and any of the military memory 402 and checkpoint memory 407, or between any two of the military memory 402 and checkpoint memory 407, etc. First local interface 403 and second local interface 410 can comprise additional systems designed to coordinate this communication, including, for example, performing load balancing. Military processor 401 and checkpoint processor 406 can be of electrical or of some other available construction.

Although military application 404 and checkpoint application 408, and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIG. 7 show the functionality and operation of an implementation of portions of military application 404 and checkpoint application 408. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as military processor 401 and checkpoint processor 406 in a computer system or other system. The machine code can be converted from the source code, etc. If embodied in hardware, each block can represent a circuit or a number of interconnected circuits to implement the specified logical function(s).

Although the flowcharts of FIG. 7 show a specific order of execution, it is understood that the order of execution can differ from that which is depicted. For example, the order of execution of two or more blocks can be scrambled relative to the order shown. Also, two or more blocks shown in succession in FIG. 7 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including military application 404 and checkpoint application 408, that comprises software or code can be embodied in any computer-readable storage medium for use by or in connection with an instruction execution system such as, for example, military processor 401 and checkpoint processor 406 in a computer system or other system. In this sense, the logic can comprise, for example, statements including instructions and declarations that can be fetched from the computer-readable storage medium and executed by the instruction execution system.

In the context of the present disclosure, a “computer-readable storage medium” can be any medium that can contain, store, or maintain the logic or application described herein for use by or in connection with the instruction execution system. The computer-readable storage medium can comprise any one of many physical media such as, for example, electronic, magnetic, optical, electromagnetic, infrared, or semiconductor media. More specific examples of a suitable computer-readable storage medium would include, but are not limited to, magnetic tapes, magnetic floppy diskettes, magnetic hard drives, memory cards, solid-state drives, USB flash drives, or optical discs. Also, the computer-readable storage medium can be a random access memory (RAM) including, for example, static random access memory (SRAM) and dynamic random access memory (DRAM), or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method of querying vehicle status comprising
storing identity information and vehicle information in a first profile in a data store, said first profile one of a plurality of profiles.
receiving from a checkpoint computer data from a visitor, said data comprising at least a portion of said identity information.
querying said profiles using said data to locate said first profile
querying a motor vehicle database using said vehicle information
obtaining a vehicle status from said motor vehicle database
sending said vehicle status to said checkpoint computer

2. The method of claim 1 wherein said identity information is fingerprint information.

3. The method of claim 1 wherein said identity information is related to an identification card.

4. The method of claim 3 wherein said identification card is a civilian identification card.

5. The method of claim 3 wherein said identification card is a military identification card.

6. The method of claim 1 wherein said identity information includes a name and a date of birth.

7. The method of claim 1 wherein said vehicle information includes a license plate.

8. The method of claim 1 wherein said vehicle information includes a vehicle identification number.

9. The method of claim 1 wherein said checkpoint computer is a mobile device.

10. The method of claim 1 wherein said checkpoint computer comprises a card reader

11. The method of claim 1 wherein said vehicle status comprises registration information.

12. The method of claim 1 wherein said vehicle status comprises title information (to find ownership information).

13. The method of claim 1 wherein said vehicle status comprises inspection information.

14. The method of claim 1 wherein said vehicle status comprises a vehicle owner name.

15. The method of claim 14 further comprising the step of running a background check using said vehicle owner name.

16. A computer readable medium having a computer readable program code embodied therein, wherein the computer readable program code is adapted to be executed to implement the method of claim 1.
